(19) United States
(12) Patent Application Publication
(10) Pub. No.: US 2024/0347706 A1
(43) Pub. Date: Oct. 17, 2024

(54) NEGATIVE ELECTRODE COMPOSITE MATERIAL, PREPARATION METHOD THEREOF, NEGATIVE ELECTRODE AND LITHIUM-ION SECONDARY BATTERY

(71) Applicant: MURATA MANUFACTURING CO., LTD., Kyoto (JP)

(72) Inventors: Li WANG, Shanghai (CN); Yan Zhou, Shanghai (CN); Yuli LI, Shanghai (CN); Kazumasa TAKESHI, Shanghai (CN)

(21) Appl. No.: 18/612,418

(22) Filed: Mar. 21, 2024

(30) Foreign Application Priority Data
Mar. 30, 2023 (CN) 202310333248.9

(51) Int. Cl. H01M 4/36; C01B 33/113; H01M 4/02; H01M 4/48; H01M 4/62; H01M 10/0525

(52) U.S. Cl. CPC H01M 4/366; C01B 33/113; H01M 4/483; H01M 4/625; H01M 10/0525; C01P 2004/84; C01P 2006/40; H01M 2004/027

(57) ABSTRACT

The present invention provides a negative electrode composite material, a preparation method thereof, a negative electrode and a lithium ion secondary battery. The negative electrode composite material comprises negative electrode active material particulates and Li₂CO₃ and LiOH at the surface of the negative electrode active material particulates, the negative electrode active material particulates comprise: particles containing silicon oxide and at least one lithium silicate selected from Li₂SiO₃ and Li₂Si₂O₅; and a carbon coating layer coating at least a part of surface of the particles, based on the weight of the negative electrode active material particulates, the content of Li₂CO₃ is greater than about 0 wt % and less than about 0.01 wt %, and the content of LiOH is greater than about 0 wt % and less than about 0.01 wt %. By the negative electrode composite material, the preparation method thereof, the negative electrode and the lithium-ion secondary battery of the present invention, the residual lithium amount can be reduced to a great extent, the processing performance of the slurry can be significantly improved, and the initial Coulombic efficiency and cycle performance of the lithium-ion secondary battery can be improved.

### CROSS REFERENCE TO RELATED APPLICATIONS

The present application claims a priority to Chinese patent application no. 202310333248.9, filed on Mar. 30, 2023, the entire contents of which are incorporated herein by reference.

### TECHNICAL FIELD

The present invention relates to the field of lithium-ion secondary batteries, and in particular, to a negative electrode composite material, a method for preparing the negative electrode composite material, and a negative electrode and a lithium-ion secondary battery which contain the negative electrode composite material.

### BACKGROUND

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries, etc. have been unable to meet the requirements of new electronic products such as mobile devices such as smart phones and fixed devices such as electric power storage systems, etc., Therefore, lithium-ion secondary batteries have attracted people's wide attention. In the development of lithium-ion secondary batteries, the capacity and performance thereof have been improved effectively. The lithium-ion secondary battery has advantages such as high energy density, high working voltage, long cycle life, and low environmental pollution, etc., and has become a new green high-energy chemical power source with extremely high development potential in the current world.

The lithium-ion secondary battery comprises a positive electrode, a negative electrode containing a negative electrode material, and an electrolyte. Various types of negative electrode materials have been developed, with silicon-based negative electrode materials being one of promising negative electrode materials. The prior art discloses that a pre-lithiation technology is used to improve the performance of the silicon-based negative electrode material, and the residual lithium amount of the silicon-based negative electrode material is controlled; however, in the prior art, the upper limit and the lower limit for controlling the residual lithium amount of the silicon-based negative electrode material are both high, it is difficult to improve the processing performance of a slurry containing a negative electrode material, and it is difficult to effectively improve the initial Coulombic efficiency and cycle performance of the lithium-ion secondary battery. Therefore, it is necessary to develop a novel negative electrode composite material, a method for preparing the negative electrode composite material, and a negative electrode and a lithium-ion secondary battery which contain the negative electrode composite material.

### SUMMARY

A main object of the present invention is to provide a negative electrode composite material, a method for preparing the negative electrode composite material, and a negative electrode and a lithium-ion secondary battery which contain the negative electrode composite material, so as to solve the problems in the prior art that the residual lithium amount of the negative electrode material is too high, it is difficult to improve the processing performance of a slurry, and it is difficult to effectively improve the initial Coulombic efficiency and cycle performance of the lithium-ion secondary battery.

In order to achieve the object, according to one aspect of the present invention, provided is a negative electrode composite material, the negative electrode composite material comprising negative electrode active material particulates and Li₂CO₃ and LiOH at the surface of the negative electrode active material particulates, the negative electrode active material particulates comprise: particles containing silicon oxide and at least one lithium silicate selected from Li₂SiO₃ and Li₂Si₂O₅; and a carbon coating layer coating at least a part of surface of the particles, based on the weight of the negative electrode active material particulates, the content of Li₂CO₃ is greater than about 0 wt % and less than about 0.01 wt %, and the content of LiOH is greater than about 0 wt % and less than about 0.01 wt %.

Further, in the negative electrode composite material, the silicon oxide is SiOₓ, where about 0.5≤x≤ about 1.6.

Further, in the negative electrode composite material, the coating amount of the carbon coating layer is in the range of about 1 wt % to about 30 wt % based on the weight of the negative electrode active material particulates.

Further, in the negative electrode composite material, the carbon coating layer coats the entire surface of the particles.

According to another aspect of the present invention, provided is a method for preparing a negative electrode composite material, the method comprising: performing carbon coating treatment on a silicon oxide precursor by using a carbon source, to form carbon-coated silicon oxide; mixing the carbon-coated silicon oxide with a lithium source to form a first mixture, performing a first heat treatment on the first mixture to form a calcined product, and then performing a second heat treatment on the calcined product to form a pre-lithiated product; and performing a washing treatment on the pre-lithiated product to form a negative electrode composite material.

Further, in the method for preparing the negative electrode composite material, the washing treatment comprises mixing the pre-lithiated product with water or an acid, preferably at a solid content of about 2 wt % to about 10 wt %, to form a second mixture, performing an ultrasonic treatment on the second mixture, then dispersing same, subsequently performing suction filtration, and finally drying the substances after suction filtration.

Further, in the method for preparing the negative electrode composite material, the acid is selected from at least one of hydrochloric acid, citric acid, oxalic acid, phosphoric acid, sulfurous acid, acetic acid, chloric acid, hypochlorous acid and boric acid.

Further, in the method for preparing the negative electrode composite material, the weight ratio of the lithium source to the carbon-coated silicon oxide is in the range of about 5:95 to about 15:85.

Further, in the method for preparing the negative electrode composite material, the temperature of performing the first heat treatment is in the range of about 500° C. to about 750° C., and the time of performing the first heat treatment is in the range of about 2 h to about 5 h.

Further, in the method for preparing the negative electrode composite material, the temperature of performing the second heat treatment is in the range of about 925° C. to about 1050° C., and the time of performing the second heat treatment is in the range of about 3 h to about 6 h.

Further, in the method for preparing the negative electrode composite material, the time of performing the ultrasonic treatment is in the range of about 10 min to about 30 min.

Further, in the method for preparing the negative electrode composite material, the time for dispersion is in the range of about 24 h to about 72 h.

Further, in the method for preparing the negative electrode composite material, the carbon source comprises at least one of an alkane, an olefin and an alkyne.

According to still another aspect of the present invention, provided is a negative electrode of a lithium-ion secondary battery, wherein the negative electrode of the lithium-ion secondary battery comprises the negative electrode composite material as described above.

According to yet another aspect of the present invention, provided is a lithium-ion secondary battery, the lithium-ion secondary battery comprising: a positive electrode, a negative electrode and a separator, wherein the negative electrode contains the negative electrode composite material as described above.

By the negative electrode composite material, the method for preparing the negative electrode composite material, and the negative electrode and the lithium-ion secondary battery which contain the negative electrode composite material in the present invention, the residual lithium amount can be reduced to a great extent, the processing performance of the slurry can be significantly improved, and the initial Coulombic efficiency and cycle performance of the lithium-ion secondary battery can be improved.

### BRIEF DESCRIPTION OF THE DRAWINGS

FIG. 1 shows an appearance photograph of a negative electrode slurry in Comparative Example 4.

FIG. 2 shows a spectrogram of Li 1s XPS (X-ray photoelectron spectroscopy) of negative electrode composite materials in Examples 1-2, Comparative Example 2, and Comparative Example 4.

### DETAILED DESCRIPTION OF THE EMBODIMENTS

It is to be noted that embodiments in the present application and features in the embodiments may be combined with one another without conflicts. Hereinafter, the present invention will be described in detail with reference to embodiments. The following embodiments are merely exemplary, and are not intended to limit the scope of protection of the present invention.

As explained in the Background, in the prior art, the residual lithium amount of the negative electrode material is too high, it is difficult to improve the processing performance of a slurry containing the negative electrode material, and it is difficult to effectively improve the initial Coulombic efficiency and cycle performance of the lithium-ion secondary battery. In view of the problems in the prior art, a typical embodiment of the present invention provides a negative electrode composite material, the negative electrode composite material comprising negative electrode active material particulates and Li₂CO₃ and LiOH at the surface of the negative electrode active material particulates, the negative electrode active material particulates comprise: particles containing silicon oxide and at least one lithium silicate selected from Li₂SiO₃ and Li₂Si₂O₅; and a carbon coating layer coating at least a part of surface of the particles, based on the weight of the negative electrode active material particulates, the content of Li₂CO₃ is greater than about 0 wt % and less than about 0.01 wt %, and the content of LiOH is greater than about 0 wt % and less than about 0.01 wt %.

A higher residual lithium value may affect the processing performance of the slurry containing the negative electrode composite material, rendering that the slurry tends to “jellify” during the preparation of the slurry by using the negative electrode composite material. After carrying out a large number of experiments, the inventor of the present invention has surprisingly found that by the present invention, the residual lithium amount can be reduced to a great extent, and a negative electrode composite material having an extremely low residual lithium amount can be obtained. The negative electrode composite material of the present invention has an extremely low residual lithium amount, can effectively avoid “jellification” of the slurry during the preparation of the slurry by using the negative electrode composite material, can significantly improve the processing performance of the slurry, and can improve the initial Coulombic efficiency and cycle performance of the lithium-ion secondary battery.

The silicon oxide of the present application can use conventional silicon oxide for a negative electrode material in the art. In some embodiments of the present invention, in the negative electrode composite material of the present invention, the silicon oxide may be SiOₓ, where about 0.5≤x≤about 1.6, preferably about 0.8≤x≤about 1.2, most preferably x=about 1.0.

In some embodiments of the present invention, in the negative electrode composite material of the present invention, based on the weight of the negative electrode active material particulates, the coating amount of the carbon coating layer is in the range of about 1 wt % to about 30 wt %, preferably, the coating amount of the carbon coating layer is in the range of about 3 wt % to about 20 wt %, and more preferably, the coating amount of the carbon coating layer is in the range of about 5 wt % to about 10 wt %. By controlling the coating amount of the carbon coating layer within the ranges above, a good balance between the capacity of the material and the coating uniformity can be obtained.

In some embodiments of the present invention, in the negative electrode composite material of the present invention, the carbon coating layer can coat the entire surface of the particles, so that the conductivity of the negative electrode composite material can be improved, the initial Coulombic efficiency is improved, the residual lithium amount is reduced more effectively, and the processing performance of the slurry is improved.

In another typical embodiment of the present invention, provided is a method for preparing a negative electrode composite material, the method comprising: performing carbon coating treatment on a silicon oxide precursor by using a carbon source, to form carbon-coated silicon oxide; mixing the carbon-coated silicon oxide with a lithium source to form a first mixture, performing a first heat treatment on the first mixture to form a calcined product, and then performing a second heat treatment on the calcined product to form a pre-lithiated product; and performing a washing treatment on the pre-lithiated product to form a negative electrode composite material.

The method for preparing the negative electrode composite material of the present invention can reduce the residual lithium amount to a great extent, can effectively avoid “jellification” of the slurry during the preparation of the slurry by using the negative electrode composite material, can significantly improve the processing performance of the slurry, can improve the initial Coulombic efficiency and cycle performance of the lithium-ion secondary battery, and can suppress gas production of the slurry. The negative electrode composite material obtained by the method according to the present invention has an extremely low residual lithium amount, can significantly improve the processing performance of the slurry, and can improve the initial Coulombic efficiency and cycle performance of the lithium-ion secondary battery.

The silicon oxide precursor, for example, SiOₓ (where about 0.5≤x≤about 1.6) in the present invention can be prepared by conventional methods in the art. In some embodiments of the present invention, the silicon oxide precursor can be prepared by the following process: mixing silicon powder of a certain particle size and silicon dioxide at a molar ratio of about 1.1:1, then placing same on a vibrator to vibrate for about 12 h until uniform mixing, taking about 1 kg of the uniformly mixed substances to press same into block bodies, then placing the block bodies on a vacuum sublimation furnace and heating same to a temperature of about 1200° C. to about 1500° C., and by adjusting the vacuum degree to be about 0 to about 30 Pa, the heating time to be about 8 h to about 10 h, the temperature at a collection end to be about 400° C. to about 800° C., preparing a block-shaped silicon oxide precursor; and placing the block-shaped silicon oxide precursor in a crusher for crushing to a millimeter level, then placing the silicon oxide precursor of a millimeter level in an airflow pulverizer for pulverization, and classifying powders with different particle sizes by means of an air flow classifier, and finally mixing large and small particles of the powders with different particle sizes to ultimately obtain the silicon oxide precursor with a required particle size.

In some embodiments of the present invention, in the method for preparing the negative electrode composite material, chemical vapor deposition is performed on the surface of the silicon oxide precursor by using at least one of an alkane, an olefin and an alkyne as a carbon source under a pressure of about 50 Pa to about 10000 Pa and a temperature of about 600° C. to about 1000° C., so as to perform carbon coating treatment on the silicon oxide precursor to form carbon-coated silicon oxide. In some embodiments of the present invention, the carbon coating treatment can be performed in equipments such as a rotary kiln, a fixed bed, or a fluidized bed.

In some embodiments of the present invention, in the method for preparing the negative electrode composite material, the washing treatment comprises mixing the pre-lithiated product with water or an acid, preferably at a solid content of about 2 wt % to about 10 wt %, e.g. about 2 wt % to about 8 wt % or about 5 wt % to about 10 wt %, to form a second mixture, performing an ultrasonic treatment on the second mixture, then dispersing same, subsequently performing suction filtration, and finally drying the substances after suction filtration. During the washing treatment, alkaline substances such as Li₂CO₃ and LiOH can be dissolved by using water, and alkaline generated on the surface of the pre-lithiated product during washing can be neutralized by using the acid; and by the ultrasonic treatment, the pre-lithiated product can be washed more clean, thereby ensuring a good washing effect, the cycle performance of the lithium-ion secondary battery can be improved. By the washing treatment, such as water washing treatment or acid washing treatment, the residual lithium amount can be reduced to a great extent, so that the residual lithium amount of the negative electrode composite material is substantially zero, which can effectively avoid “jellification” of the slurry during the preparation of the slurry by using the negative electrode composite material, can significantly improve the processing performance of the slurry, and can further improve the initial Coulombic efficiency and cycle performance of the lithium-ion secondary battery. By controlling the solid content in the described ranges, a sufficient amount of cleaning agent for cleaning per unit mass of the pre-lithiated product can be ensured, thereby ensuring a good cleaning effect.

In some embodiments of the present invention, the prepared pre-lithiated product, e.g., pre-lithiated SiOₓ (about 0.5≤x≤about 1.6) material is mixed with water at a solid content of about 2 wt % to about 10 wt % to form a second mixture, an ultrasonic treatment is first performed on the second mixture at room temperature for about 10 min to about 30 min; and then a magnetic stirrer is used to disperse the second mixture for about 24 h to about 72 h, then suction filtration is performed, and after the suction filtration, pure water is poured onto the substances on filter paper, and washing is performed twice in the form of suction filtration, finally, vacuum drying is performed at about 100° C. to about 120° C. for about 3 to about 8 hours on the substances after suction filtration.

In some embodiments of the present invention, in the method for preparing the negative electrode composite material, in order to better neutralize alkali produced on the surface of the pre-lithiated product during washing, the acid is selected from at least one of hydrochloric acid, citric acid, oxalic acid, phosphoric acid, sulfurous acid, acetic acid, chloric acid, hypochlorous acid and boric acid.

In some embodiments of the present invention, the prepared pre-lithiated product, e.g., pre-lithiated SiOₓ (about 0.5≤x≤about 1.6) material is mixed with at least one of hydrochloric acid, citric acid, oxalic acid, phosphoric acid, sulfurous acid, acetic acid, chloric acid, hypochlorous acid and boric acid, etc. (e.g. citric acid at a concentration of about 1 mol/L) at a solid content of about 2 wt % to about 10 wt % to form a second mixture, an ultrasonic treatment is first performed on the second mixture at room temperature for about 10 min to about 30 min; and then a magnetic stirrer is used to disperse the second mixture for about 24 h to about 72 h, then suction filtration is performed, and after the suction filtration, pure water is poured onto the substances on filter paper, and washing is performed twice in the form of suction filtration, finally, vacuum drying is performed at about 100° C. to about 120° C. for about 3 to about 8 hours on the substances after suction filtration.

In some embodiments of the present invention, in the method for preparing the negative electrode composite material, the weight ratio of the lithium source to the carbon-coated silicon oxide is in the range of about 5:95 to about 15:85. By controlling the weight ratio of the lithium source to the carbon-coated silicon oxide to be in the described range, it can be ensured that the silicon oxide is sufficiently pre-lithiated, the residual lithium amount can be reduced, and the initial Coulombic efficiency and cycle performance of the lithium-ion secondary battery can be further improved. In some embodiments of the present invention, the lithium source may comprise any one of lithium ingot, lithium metal powder and lithium foil.

In some embodiments of the present invention, in the method for preparing the negative electrode composite material, the temperature of performing the first heat treatment is in the range of about 500° C. to about 750° C., and the time of performing the first heat treatment is in the range of about 2 h to about 5 h. By controlling the temperature and time of performing the first heat treatment within the described ranges, lithium diffusion in a solid phase reaction is facilitated, sufficient pre-lithiation of silicon oxide can be ensured, the residual lithium amount can be reduced, and the initial Coulombic efficiency and cycle performance of the lithium-ion secondary battery can be further improved.

In some embodiments of the present invention, in the method for preparing the negative electrode composite material, the temperature of performing the second heat treatment is in the range of about 925° C. to about 1050° C., and the time of performing the second heat treatment is in the range of about 3 h to about 6 h. By controlling the temperature of performing the second heat treatment to be within the range above, it is beneficial for the decomposition of Li₂CO₃ and LiOH (the decomposition temperature being about 924° C.), and the decomposition product Li₂O of Li₂CO₃ and LiOH starts to be sublimated at about 1000° C. or higher, thereby being beneficial to reducing the residual lithium amount to a great extent. By controlling the temperature and time of performing the second heat treatment within the described ranges, sufficient pre-lithiation of silicon oxide can be ensured, the residual lithium amount can be reduced to a great extent, and the initial Coulombic efficiency and cycle performance of the lithium-ion secondary battery can be further improved.

In some embodiments of the present invention, a lithium source and carbon-coated silicon oxide are ground and mixed at a weight ratio of about 5:95 to about 15:85 under the protection of an inert argon atmosphere to form a first mixture, then the first mixture is placed in a rotary kiln and calcined for about 2 h to about 5 h under heat preservation at about 500° C. to about 750° C. and under an argon atmosphere, such that the carbon-coated silicon oxide is fully reacted with the lithium metal, and then heat treatment is performed at about 925° C. to about 1050° C. for about 3 h to about 6 h, to obtain the pre-lithiated product.

In some embodiments of the present invention, in the method for preparing the negative electrode composite material, the time of performing the ultrasonic treatment is in the range of about 10 min to about 30 min. By controlling the time of performing the ultrasonic treatment to be within the described range, it is beneficial to clean the residual lithium in holes, so that the pre-lithiated product can be washed more clean, and a good washing effect is ensured; moreover, damage to the particles of the pre-lithiated product can be avoided, and effect on the particle size distribution can be avoided.

In some embodiments of the present invention, in the method for preparing the negative electrode composite material, mainly in consideration of energy consumption, time cost and washing effect, the time for dispersion may be controlled within the range of about 24 h to about 72 h. If the time for dispersion is too short, the washing may be not thorough; and if the time for dispersion is too long, energy consumption and time cost will be high. By controlling the time for dispersion to be within the described range, not only a good washing effect can be ensured, but also the energy consumption and time cost can be reduced.

In some embodiments of the present invention, in the method for preparing the negative electrode composite material, in order to better achieve carbon coating on at least a part of the surface of the silicon oxide and obtain a good coating effect, the carbon source comprises at least one of an alkane, an olefin and an alkyne.

In still another typical embodiment of the present invention, provided is a negative electrode of a lithium-ion secondary battery, the negative electrode of the lithium-ion secondary battery comprises the negative electrode composite material as described above. As the negative electrode of the lithium-ion secondary battery of the present invention comprises the negative electrode composite material as described above, the residual lithium amount can be reduced to a great extent, the processing performance of the slurry can be significantly improved, and the initial Coulombic efficiency and cycle performance of the lithium-ion secondary battery can be improved.

A negative electrode sheet of the present invention can be prepared according to conventional methods in the art. For example, the negative electrode composite material of the present invention, a conductive agent and a binder may be dispersed in water as a solvent to form a uniform negative electrode slurry, the negative electrode slurry is coated on a negative electrode current collector, and after drying, a negative electrode sheet is obtained. The conductive agent may be conductive carbon black, conductive graphite, vapor grown carbon fibers, carbon nanotubes, or any combination thereof. The binder may be one or more of styrene-butadiene rubber (SBR), polyacrylic acid (PAA), and polyimide (PI), etc., and is preferably a polyacrylic acid (PAA) binder.

In yet another typical embodiment of the present invention, provided is a lithium-ion secondary battery, the lithium-ion secondary battery comprising: a positive electrode, a negative electrode and a separator, the negative electrode contains the negative electrode composite material as described above. As the lithium-ion secondary battery of the present invention comprises the negative electrode composite material as described above, the residual lithium amount can be reduced to a great extent, the processing performance of the slurry can be significantly improved, and the initial Coulombic efficiency and cycle performance of the lithium-ion secondary battery can be improved.

The positive electrode of the present invention comprises a positive electrode current collector and a positive electrode active material layer containing a positive electrode active material. The positive electrode active material layer is formed on both surfaces of the positive electrode current collector. A metal foil such as an aluminum foil, a nickel foil, or a stainless steel foil may be used as the positive electrode current collector.

The positive electrode active material layer contains one or more positive electrode materials capable of intercalating and de-intercalating lithium ions as the positive electrode active material, and may contain, as necessary, other material, for example, a positive electrode binder and/or a positive electrode conductive agent.

Preferably, the positive electrode material is a lithium-containing compound. Examples of such a lithium-containing compound comprise a lithium-transition metal composite oxide, a lithium-transition metal phosphate compound, and the like. The lithium-transition metal composite oxide is an oxide containing Li and one or two or more transition metal elements as constituent elements, and the lithium-transition metal phosphate compound is a phosphate compound containing Li and one or two or more transition metal elements as constituent elements. The transition metal element is advantageously one or more of Co, Ni, Mn and Fe, and the like.

Examples of the lithium-transition metal composite oxide may comprise, for example, LiCoO₂ and LiNiO₂, and the like. Examples of the lithium-transition metal phosphate compound may comprise, for example, LiFePO₄ and LiFe₁₋ᵤMnᵤPO₄ (about 0<u<about 1), and the like.

The negative electrode of the present invention comprises a negative electrode current collector and a negative electrode active material layer containing a negative electrode composite material. The negative electrode active material layer is formed on both surfaces of the negative electrode current collector. A metal foil such as a copper (Cu) foil, a carbon-coated copper foil, a nickel foil, or a stainless steel foil may be used as the negative electrode current collector.

The separator of the present invention is used to separate the positive electrode from the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin comprise polytetrafluoroethylene, polypropylene and polyethylene, and the like.

In embodiments of the present invention, when the lithium-ion secondary battery is charged, for example, lithium ions are de-intercalated from the positive electrode and are intercalated into the negative electrode through the electrolyte impregnated in the separator. When the lithium-ion secondary battery is discharged, for example, lithium ions are de-intercalated from the negative electrode and are intercalated into the positive electrode through the electrolyte impregnated in the separator.

Hereinafter, the present application will be further described in detail in combination with specific examples, and these examples cannot be understood as limiting the scope of protection of the present application.

### Example 1

### Preparation of Negative Electrode Composite Material

Chemical vapor deposition is performed on the surface of 20 g of a silicon oxide precursor SiOₓ (x=1) material by using methane as a carbon source under a pressure of 50 Pa at a temperature of 920° C., so as to perform carbon coating treatment on the silicon oxide precursor SiOₓ (x=1) material to form 21 g of carbon-coated SiOₓ (x=1) material.

A lithium ingot and a carbon-coated SiOₓ (x=1) material are ground and mixed at a weight ratio of 10:90 under the protection of an inert argon atmosphere to form a first mixture, then the first mixture is placed in a rotary furnace and calcined for 3 h under heat preservation at 550° C. and under an argon atmosphere, such that the carbon-coated SiOₓ material is fully reacted with the lithium metal, and then heat treatment is performed at 925° C. for 3 h, to obtain a pre-lithiated SiOₓ material.

The prepared pre-lithiated SiOₓ material and hydrochloric acid with a concentration of 1 mol/L are taken and placed into a beaker at a solid content of 8 wt % and mixed to form a second mixture, and an ultrasonic treatment is first performed on the second mixture at room temperature for 20 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Preparation of Negative Electrode Sheet

4 g of the negative electrode composite material prepared by the described process is weighed; the negative electrode composite material, conductive carbon black Super-P as a conductive agent and polyacrylic acid PAA as a binder at a mass ratio of 82:8:10 are fully stirred and mixed in a suitable amount of deionized water; by adjusting same to a solid content of 42 wt %, a uniform negative electrode slurry is formed, and then the negative electrode slurry is coated on the surface of a copper foil as a negative electrode current collector, and after drying, a negative electrode sheet is obtained.

### Battery Assembling

The prepared negative electrode sheet, a separator, a lithium sheet, a gasket and a battery housing are successively stacked and injected with 100 μl of electrolyte, and sealed by a sealing machine and assembled into a half-cell required.

### Example 2

The half-cell is prepared by using the same method as that in Example 1, and the differences lie in that: a lithium ingot and a carbon-coated SiOₓ (x=1) material are ground and mixed at a weight ratio of 15:85 under the protection of an inert argon atmosphere to form a first mixture, then the first mixture is placed in a rotary furnace and calcined for 4 h under heat preservation at 600° C. and under an argon atmosphere, such that the carbon-coated SiOₓ material is fully reacted with the lithium metal, and then heat treatment is performed at 1000° C. for 4 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 15 min; and then a magnetic stirrer is used to disperse the second mixture for 36 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 3

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 2 h under heat preservation at 500° C. and under an argon atmosphere, such that the carbon-coated SiOₓ material is fully reacted with the lithium metal, and then heat treatment is performed at 1050° C. for 6 h, to obtain a pre-lithiated SiOₓ material;

The prepared pre-lithiated SiOₓ material and hydrochloric acid with a concentration of 1 mol/L are taken and placed into a beaker at a solid content of 2 wt % and mixed to form a second mixture, and an ultrasonic treatment is first performed on the second mixture at room temperature for 30 min; and then a magnetic stirrer is used to disperse the second mixture for 72 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 4

The half-cell is prepared by using the same method as that in Example 1, and the differences lie in that: a lithium ingot and a carbon-coated SiOₓ (x=1) material are ground and mixed at a weight ratio of 15:85 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 1025° C. for 4 h, to obtain a pre-lithiated SiOₓ material;

The prepared pre-lithiated SiOₓ material and hydrochloric acid with a concentration of 1 mol/L are taken and placed into a beaker at a solid content of 10 wt % and mixed to form a second mixture, and an ultrasonic treatment is first performed on the second mixture at room temperature for 10 min; and then a magnetic stirrer is used to disperse the second mixture for 24 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 5

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 2 h under heat preservation at 650° C. and under an argon atmosphere, such that the carbon-coated SiOₓ material is fully reacted with the lithium metal, and then heat treatment is performed at 1050° C. for 6 h, to obtain a pre-lithiated SiOₓ material;

The prepared pre-lithiated SiOₓ material and pure water are taken and placed into a beaker at a solid content of 2 wt % and mixed to form a second mixture, and an ultrasonic treatment is first performed on the second mixture at room temperature for 30 min; and then a magnetic stirrer is used to disperse the second mixture for 72 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 1

The half-cell is prepared by using the same method as that in Example 1, and the differences lie in that: a lithium ingot and a carbon-coated SiOₓ (x=1) material are ground and mixed at a weight ratio of 15:85 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 775° C. for 4 h, to obtain a pre-lithiated SiOₓ material;

The prepared pre-lithiated SiOₓ material and hydrochloric acid with a concentration of 1 mol/L are taken and placed into a beaker at a solid content of 10 wt % and mixed to form a second mixture, and an ultrasonic treatment is first performed on the second mixture at room temperature for 10 min; and then a magnetic stirrer is used to disperse the second mixture for 24 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 2

The half-cell is prepared by using the same method as that in Example 1, and the differences lie in that: a lithium ingot and a carbon-coated SiOₓ (x=1) material are ground and mixed at a weight ratio of 2:98 under the protection of an inert argon atmosphere to form a first mixture, then the first mixture is placed in a rotary furnace and calcined for 2 h under heat preservation at 400° C. and under an argon atmosphere, such that the carbon-coated SiOₓ material is fully reacted with the lithium metal, and then heat treatment is performed at 950° C. for 7 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 10 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 3

The half-cell is prepared by using the same method as that in Example 1, and the differences lie in that: a lithium ingot and a carbon-coated SiOₓ (x=1) material are ground and mixed at a weight ratio of 15:85 under the protection of an inert argon atmosphere to form a first mixture, then the first mixture is placed in a rotary furnace and calcined for 4 h under heat preservation at 600° C. and under an argon atmosphere, such that the carbon-coated SiOₓ material is fully reacted with the lithium metal, and then heat treatment is performed at 1000° C. for 4 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture; and a magnetic stirrer is used to disperse the second mixture at room temperature for 36 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 4

The half-cell is prepared by using the same method as that in Example 1, and the differences lie in that: a lithium ingot and a carbon-coated SiOₓ (x=1) material are ground and mixed at a weight ratio of 10:90 under the protection of an inert argon atmosphere to form a first mixture, then the first mixture is placed in a rotary furnace and calcined for 3 h under heat preservation at 550° C. and under an argon atmosphere, such that the carbon-coated SiOₓ material is fully reacted with the lithium metal, and then heat treatment is performed at 925° C. for 3 h, to obtain a pre-lithiated SiOₓ material;

The pre-lithiated SiOₓ material is not subjected to a washing treatment, and instead the pre-lithiated SiOₓ material is directly used as a negative electrode composite material.

### Comparative Example 5

The half-cell is prepared by using the same method as that in Example 1, and the differences lie in that: a lithium ingot and a carbon-coated SiOₓ (x=1) material are ground and mixed at a weight ratio of 30:70 under the protection of an inert argon atmosphere to form a first mixture, then the first mixture is placed in a rotary furnace and calcined for 5 h under heat preservation at 600° C. and under an argon atmosphere, such that the carbon-coated SiOₓ material is fully reacted with the lithium metal, and then heat treatment is performed at 820° C. for 2 h, to obtain a pre-lithiated SiOₓ material;

The prepared pre-lithiated SiOₓ material and pure water are taken and placed into a beaker at a solid content of 5 wt % and mixed to form a second mixture; and a magnetic stirrer is used to disperse the second mixture at room temperature for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Test of Physical Properties of Materials

The negative electrode composite materials of Examples 1-5 and Comparative Examples 1-5 are tested, to obtain the results of the content of Li₂CO₃ and the content of LiOH.

Neutralization titration method: taking the negative electrode composite material and pure water at a mass ratio of 1:9 and placing into a beaker and mixing same, dispersing the negative electrode composite material for 1 h at room temperature by using a magnetic stirrer, standing still for 1 h, and filtering the dispersion liquid. 10 mL of the resulting filtrate is subjected to automatic titration with 0.2 M of hydrochloric acid by using an acid-base autotitrator, to obtain a first terminal point (a mL) and a second terminal point (b mL).

Content of Li₂CO₃=[amount of pure water (g)/amount of filtrate (g)]×2×(b/1000)×(equivalent concentration of titration amount of hydrochloric acid×coefficient)×(½)×(molar mass of Li₂CO₃)×[100(%)/amount of sample (g)]

Content of LiOH=[amount of pure water (g)/amount of filtrate (g)]×[(a−b)/1000]×(equivalent concentration of titration amount of hydrochloric acid×coefficient)×(½)×(molar mass of LiOH)×[100(%)/amount of sample (g)].

### Test of Battery Performance

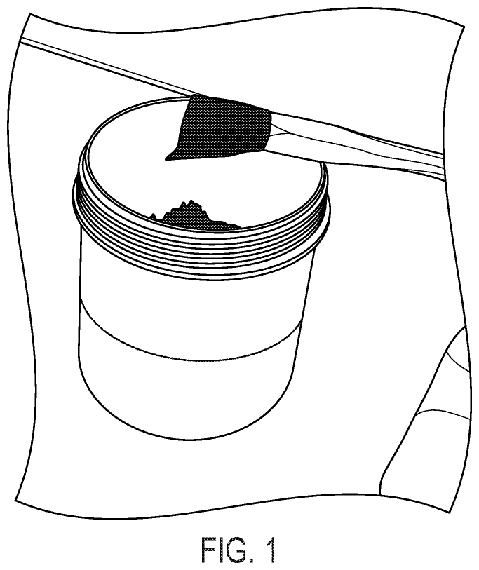

The half-cells of Examples 1-5 and Comparative Examples 1-5 are subjected to a charge and discharge test under an environment of 25° C. at a voltage ranging from 0 V to 1.5 V. The half-cells in the examples and comparative examples are firstly subjected to a cycle test once with a charge and discharge current of 0.1C under an environment of 25° C. (the range of the charge and discharge voltage is 0 V-1.5 V), so as to determine the initial discharge capacity and the initial Coulombic efficiency of the cells; and then the cells are subjected to a charge and discharge cycle test for 50 times by using a 1C current (the charge and discharge cut-off voltage is 0 V-1.5 V), so as to determine the capacity retention rate of the cells after 50 cycles. Initial Coulombic Efficiency (%)=initial discharge capacity/initial charge capacity×100%. The experimental results are shown in Table 1 below and FIGS. 1-2.

TABLE 1
Physical properties of materials and electrochemical performance test results

| | | | | Initial | Initial | Discharge |
|---|---|---|---|---|---|---|
| | Content of | Content of | | discharge | Coulombic | capacity retention |
| Experiment | Li₂CO₃ | LiOH | Composition of | capacity | efficiency | rate after 50 cycles |
| No. | (wt %) | (wt %) | lithium silicate | (mAh/g) | (%) | (%) |
| Example 1 | 0.005 | 0.004 | Li₂SiO₃, Li₂Si₂O₅ | 1225 | 87.5 | 90.1 |
| Example 2 | 0.008 | 0.006 | Li₂SiO₃, Li₂Si₂O₅ | 1211 | 88.1 | 89.1 |
| Example 3 | 0.001 | 0.001 | Li₂SiO₃, Li₂Si₂O₅ | 1205 | 89.0 | 89.5 |
| Example 4 | 0.009 | 0.009 | Li₂SiO₃, Li₂Si₂O₅ | 1285 | 88.9 | 87.7 |
| Example 5 | 0.005 | 0.006 | Li₂SiO₃, Li₂Si₂O₅ | 1195 | 86.8 | 88.6 |
| Comparative | 0.023 | 0.105 | Li₂SiO₃, Li₂Si₂O₅ | 1201 | 86.0 | 85.7 |
| Example 1 | | | | | | |
| Comparative | 0.486 | 0.588 | Li₂SiO₃, Li₂Si₂O₅ | 1301 | 78.5 | 80.2 |
| Example 2 | | | | | | |
| Comparative | 0.01 | 0.01 | Li₂SiO₃, Li₂Si₂O₅ | 1188 | 85.9 | 85.9 |
| Example 3 | | | | | | |
| Comparative | 1.458 | 1.024 | Li₂SiO₃, Li₂Si₂O₅ | 1195 | 78.2 | 52.2 |
| Example 4 | | | | | | |
| Comparative | 0.505 | 0.128 | Li₂SiO₃, Li₂Si₂O₅ | 1292 | 84.2 | 81.5 |
| Example 5 | | | | | | |

It can be seen from the test results that the examples above of the present invention achieve the following technical effects:

By comparing the results of Examples 1-5 with those of Comparative Examples 1-5, it can be seen that: compared with Comparative Examples 1-5 in which the content of Li₂CO₃ and the content of LiOH based on the weight of negative electrode active material particulates are not within the ranges of the present invention, the cells of Examples 1-5 in which based on the weight of the negative electrode active material particulates, the content of Li₂CO₃ is greater than about 0 wt % and less than about 0.01 wt % and the content of LiOH is greater than about 0 wt % and less than about 0.01 wt % have higher initial Coulombic efficiency and higher discharge capacity retention ratio after 50 cycles.

FIG. 2 shows a spectrogram of Li 1s XPS (X-ray photoelectron spectroscopy) of negative electrode composite materials in Examples 1-2, Comparative Example 2, and Comparative Example 4. The XPS spectrogram shows a comparison of the amounts of lithium carbonate Li₂CO₃ as one of the residual lithium components in the negative electrode composite materials of Examples 1-2, Comparative Example 2 and Comparative Example 4. As can be seen from FIG. 2, no Li₂CO₃ peak exists in the XPS spectrogram of the negative electrode composite materials of Examples 1-2. This indicates that the amounts of Li₂CO₃ in the negative electrode composite materials of Examples 1-2 do not reach the amount required for XPS test.

By comparing the results of Example 1 with those of Comparative Example 4, it can be seen that by performing a washing treatment on the pre-lithiated SiOₓ material, a negative electrode composite material having an extremely low Li₂CO₃ content and an extremely low LiOH content can be obtained, the residual lithium amount can be reduced to a great extent, the processing performance of the slurry can be significantly improved, and the initial discharge capacity, the initial Coulombic efficiency and the discharge capacity retention rate after 50 cycles of the cells can be increased. FIG. 1 shows an appearance photograph of a negative electrode slurry in Comparative Example 4. It can be seen from FIG. 1 that as the residual lithium amount of the negative electrode composite material in Comparative Example 4 is relatively high, jellification occurs in the negative electrode slurry.

By comparing the results of Example 2 with those of Comparative Example 3, it can be seen that when the washing treatment comprises performing ultrasonic treatment on the second mixture, a negative electrode composite material having an extremely low Li₂CO₃ content and an extremely low LiOH content can be obtained, the residual lithium amount can be reduced, the processing performance of the slurry can be significantly improved, and the initial discharge capacity, the initial Coulombic efficiency and the discharge capacity retention rate after 50 cycles of the cells can be increased.

By comparing the results of Example 4 with those of Comparative Example 1, it can be seen that when the temperature of performing the second heat treatment is in the range of about 925° C. to about 1050° C., a negative electrode composite material having an extremely low Li₂CO₃ content and an extremely low LiOH content can be obtained, the residual lithium amount can be reduced, the processing performance of the slurry can be significantly improved, and the initial discharge capacity, the initial Coulombic efficiency and the discharge capacity retention rate after 50 cycles of the cells can be increased.

It can be seen from the described battery performance test results: by the negative electrode composite material, the method for preparing the negative electrode composite material, and the negative electrode and the lithium-ion secondary battery which contain the negative electrode composite material in the present invention, the residual lithium amount can be reduced to a great extent, the processing performance of the slurry can be significantly improved, and the initial Coulombic efficiency and cycle performance of the lithium-ion secondary battery can be improved.

The content as described above is only preferred embodiments of the present invention and is not intended to limit the present invention. For a person skilled in the art, the present invention may have various modifications and variations. Any modifications, equivalent replacements, improvements, etc. made within the spirit and principle of the present invention shall all fall within the scope of protection of the present invention.

1. A negative electrode composite material, wherein the negative electrode composite material comprises negative electrode active material particulates and Li₂CO₃ and LiOH at the surface of the negative electrode active material particulates, the negative electrode active material particulates comprise:
particles containing silicon oxide and at least one lithium silicate selected from Li₂SiO₃ and Li₂Si₂O₅; and
a carbon coating layer coating at least a part of surface of the particles,
based on the weight of the negative electrode active material particulates, the content of Li₂CO₃ is greater than about 0 wt % and less than about 0.01 wt %, and the content of LiOH is greater than about 0 wt % and less than about 0.01 wt %.

2. The negative electrode composite material according to claim 1, wherein the silicon oxide is SiOₓ, where about 0.5≤x≤about 1.6.

3. The negative electrode composite material according to claim 1, wherein the coating amount of the carbon coating layer is in the range of about 1 wt % to about 30 wt % based on the weight of the negative electrode active material particulates.

4. The negative electrode composite material according to claim 1, wherein the carbon coating layer coats the entire surface of the particles.

5. A method for preparing a negative electrode composite material, wherein the method comprises:
performing carbon coating treatment on a silicon oxide precursor by using a carbon source, to form carbon-coated silicon oxide;
mixing the carbon-coated silicon oxide with a lithium source to form a first mixture, performing a first heat treatment on the first mixture to form a calcined product, and then performing a second heat treatment on the calcined product to form a pre-lithiated product; and
performing a washing treatment on the pre-lithiated product to form the negative electrode composite material.

6. The method for preparing the negative electrode composite material according to claim 5, wherein the washing treatment comprises mixing the pre-lithiated product with water or an acid, preferably at a solid content of about 2 wt % to about 10 wt %, to form a second mixture, performing an ultrasonic treatment on the second mixture, then dispersing same, subsequently performing suction filtration, and finally drying the substances after suction filtration.

7. The method for preparing the negative electrode composite material according to claim 6, wherein the acid is selected from at least one of hydrochloric acid, citric acid, oxalic acid, phosphoric acid, sulfurous acid, acetic acid, chloric acid, hypochlorous acid and boric acid.

8. The method for preparing the negative electrode composite material according to claim 5, wherein the weight ratio of the lithium source to the carbon-coated silicon oxide is in the range of about 5:95 to about 15:85.

9. The method for preparing the negative electrode composite material according to claim 5, wherein the temperature of performing the first heat treatment is in the range of about 500° C. to about 750° C., and the time of performing the first heat treatment is in the range of about 2 h to about 5 h.

10. The method for preparing the negative electrode composite material according to claim 5, wherein the temperature of performing the second heat treatment is in the range of about 925° C. to about 1050° C., and the time of performing the second heat treatment is in the range of about 3 h to about 6 h.

11. The method for preparing the negative electrode composite material according to claim 6, wherein the time of performing the ultrasonic treatment is in the range of about 10 min to about 30 min.

12. The method for preparing the negative electrode composite material according to claim 6, wherein the time for the dispersion is in the range of about 24 h to about 72 h.

13. The method for preparing the negative electrode composite material according to claim 5,
wherein the carbon source comprises at least one of an alkane, an olefin and an alkyne.

14. A lithium-ion secondary battery, wherein the lithium-ion secondary battery comprises:
a positive electrode,
a negative electrode, and
a separator,
wherein the negative electrode comprises the negative electrode composite material according to claim 1.
